(19) United States
(12) Patent Application Publication
(10) Pub. No.: US 2005/0115057 A1
(43) Pub. Date: Jun. 2, 2005

(54) Method of manufacturing a magnetic head, and magnetic head manufacturing apparatus

(75) Inventors: Kazuaki Takanuki, Tokyo (JP); Osamu Shindo, Tokyo (JP); Akimasa Nakao, Tokyo (JP); Satoshi Yamaguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/986,387

(22) Filed: Nov. 12, 2004

(30) Foreign Application Priority Data
Nov. 28, 2003 (JP) 2003-398383

(51) Int. Cl. G11B 5/127; B23P 19/00

(52) U.S. Cl. 29/603.04; 29/737

(57) ABSTRACT

A method of manufacturing a magnetic head, and a magnetic head manufacturing apparatus, are provided, which make it possible to post mount a slider to a suspension even when the suspension and an actuator block are assembled together in advance, thus preventing the slider from being destroyed due to ESD or the like. First, a plurality of opposing suspensions are pushed open, forming a gap having a prescribed height between distal ends of the suspensions to which the slider is to be attached. Both side surfaces of the slider are then gripped by pressing surfaces formed on a gripping mechanism. An ABS of the slider is made to contact a horizontal regulating surface formed on the gripping mechanism, thus regulating the horizontal attitude of the slider. The slider, which is gripped by the gripping mechanism, is then inserted into the gap. A rear surface of the slider is attached to the distal end of the suspension through a connecting member.

### BACKGROUND OF THE INVENTION

1. Field of the Invention

The present invention relates to a method of manufacturing a magnetic head, and to a magnetic head manufacturing apparatus. In particular, the present invention relates to a method of manufacturing a magnetic head, and a magnetic head manufacturing apparatus, suitable for post mounting of a slider onto a suspension attached to an actuator block.

2. Related Background Art

Hard disk drives (hereinafter called HDDs) are increasing in capacity and being made thinner. Together with these advances, magnetic heads (20%, 30% sliders) are also being made smaller.

When bonding a slider, on which a giant magneto-resistive (GMR) element is formed, to a suspension with conventional processes of manufacturing magnetic heads, positioning of the slider is performed first using the external shape of the slider as a reference. An adhesive agent is applied to a rear surface side of the slider (side opposite to a side where an air bearing surface (ABS) is formed) after positioning the slider, and the slider side is made to contact a distal end of the suspension, which has been positioned by using a tooling hole. The slider and the distal end of the suspension are bonded together through the adhesive. It should be noted that a suction nozzle slightly smaller than the surface area of the slider is generally used in moving the slider to the distal end of the suspension.

After bonding the slider and the suspension, thus forming a head gimble assembly (HGA), the HGA is assembled together with an actuator block, forming a head stack assembly (HSA) (refer to JP 4-17174 A, for example).

However, problems like those described below exist with the conventional magnetic head manufacturing methods described above.

Namely, the processing time is long because the slider undergoes the process for assembling the HSA after undergoing the process for assembling the HGA. A danger thus exists that elements within the slider will be damaged due to electrostatic discharge (ESD) or the like. When a non-defective slider at the HGA assembly state becomes defective during processing, the defects in the slider are discovered after HSA assembly. Finished product yield consequently decreases, and there are cost increases.

Methods in which the suspension and the actuator block are assembled in advance, and then the slider is attached to the slider through post mounting have been considered in order to resolve problems like those described above. However, a pair of suspensions that sandwich a magnetic disk face each other in the HSA. With a method in which the slider is attached to one suspension from a vertical direction by using an absorption nozzle, there is a problem in that the suction nozzle interferes with the other suspension facing the one suspension, making it impossible to attach the slider.

### SUMMARY OF THE INVENTION

The present invention has been made in view of the conventional problems described above. An object of the present invention is to provide a method of manufacturing a magnetic head, and a magnetic head manufacturing apparatus, capable of post mounting a slider even when a suspension and an actuator block are previously assembled together.

The present invention has been made based on the finding that a slider can be attached to a distal end of a suspension by accurately maintaining the height of the distal end of the suspension, which is to be attached to an actuator block, and inserting the slider between suspensions that face each other by using a gripping mechanism.

That is, a method of manufacturing a magnetic head according to one aspect of the present invention relates to a method of manufacturing a magnetic head in which a slider is attached to suspensions, including: setting distal ends of the suspensions, to which the slider is to be attached, at prescribed heights; gripping both side surfaces of the slider by pressing surfaces formed on a gripping mechanism; regulating a horizontal attitude of the slider by bringing an ABS of the slider into contact with a horizontal regulating surface formed on the gripping mechanism; moving the slider, which is held by the gripping mechanism, to the distal ends of the suspensions; and attaching a rear surface of the slider to the distal ends of the suspensions through connecting means.

Further, a method of manufacturing a magnetic head according to another aspect of the present invention relates to a method of manufacturing a magnetic head in which a slider is attached to suspensions attached to an actuator block, the method including: pushing open a plurality of the suspensions that face each other, forming a gap having a prescribed height between distal ends of the suspensions to which the slider is to be attached; gripping both side surfaces of the slider by pressing surfaces formed on a gripping mechanism; regulating a horizontal attitude of the slider by bringing an ABS of the slider into contact with a horizontal regulating surface formed on the gripping mechanism; inserting the slider, which is held by the gripping mechanism, into the gap; and attaching a rear surface of the slider to the distal ends of the suspensions by using connecting means.

Further, it is desirable that insertion of the gripping mechanism between the suspensions be performed from a longitudinal direction of the suspensions, thus preventing interference with a surface of the slider on which a terminal electrode is formed. Further, the holding of the slider by the gripping mechanism preferably includes gripping both the side surfaces of the slider by the pressing surfaces, making the gripping mechanism approach the slider, and bringing the horizontal regulating surface into contact with the ABS of the slider.

Further, a magnetic head manufacturing apparatus according to one aspect of the present invention relates to a magnetic head manufacturing apparatus in which a slider is attached to suspensions, including: a positioning member for retaining distal ends of the suspensions at prescribed heights; a gripping mechanism made from two block structure members that are capable of sliding with respect to each other, the gripping mechanism being adapted to grip the slider by pressing with pressing surfaces formed on the block members and to horizontally regulate the slider by a horizontal regulating surface that is formed on one of the block members and contacts an ABS of the slider; and driving means for operating the gripping mechanism to move the slider toward distal ends of the suspensions and to press the slider onto the distal ends of the suspensions, based on position information on the distal ends of the suspensions and position information on the slider that is held by the gripping mechanism.

Further, a magnetic head manufacturing apparatus according to another aspect of the present invention relates to a magnetic head manufacturing apparatus in which a slider is attached to suspensions attached to an actuator block, the magnetic head manufacturing apparatus including: an insertion member that is inserted between a plurality of the suspensions that face each other, for holding distal ends of the suspensions, to which the slider is to be attached, at a prescribed height and for forming a gap between the suspensions that face each other; a gripping mechanism made from two block structure members that are capable of sliding with respect to each other, the gripping mechanism being adapted to grip the slider by pressing with pressing surfaces formed on the block members and to horizontally regulate the slider by a horizontal regulating surface that is formed on one of the block members and contacts an ABS of the slider; and driving means for operating the gripping mechanism to insert the slider into the gap between the suspensions, and to press the slider onto the distal ends of the suspensions, based on position information on the distal ends of the suspensions and position information on the slider that is held by the gripping mechanism.

Further, it is desirable that the gripping mechanism be disposed by the side in a longitudinal direction of the suspensions, thus preventing interference with a surface of the slider on which a terminal electrode is formed.

Further, it is desirable that urging forces applied by the pressing surfaces to the slider be made uneven between the block members, and a position of the slider with respect to the gripping mechanism be set by pressing with the block member for which a larger urging force is set. Further, it is preferable that rotation driving means be attached to the gripping mechanism, for making a rotation axis of the gripping mechanism pass through a vicinity of a center of mass of the slider set by pressing of the block members, and that operation of the rotation driving means enable rotation of the slider together with rotation of the gripping mechanism.

Further, it is desirable that the pressing surfaces each have a beveled portion formed at their edge portions that are exposed on a rear surface side of the slider, thus reducing reflectivity relative to the block member and the slider that are arranged on both sides of the beveled portion.

According to the configuration described above, after first fixing in position the actuator block to which the plurality of suspensions are attached, the insertion member is then placed between the plurality of suspensions, forming a gap between the suspensions. The distal ends of the suspensions to which the slider is to be attached are set in advance to predetermined heights with respect to a reference surface in the actuator block (such as a bottom surface that serves as a working reference or a reference surface for attachment onto an HDD), by thus placing the insertion member between the suspensions.

On the other hand, the attitude of an ABS of the slider that is to be attached to the suspensions is adjusted such that the ABS of the slider faces upward. The gripping mechanism is then moved to a position above the slider by using the driving means. After the gripping mechanism has moved to the position above the slider, the gripping mechanism is lowered to a position immediately above a position where the horizontal regulating surface of the gripping mechanism contacts the ABS of the slider. A space between a pair of pressing surfaces formed on the two block members is then made smaller, and the slider is gripped from both sides. After gripping both side portions of the slider, the gripping mechanism is moved further downward, making the ABS of the slider contact the horizontal regulating surface, thus making the attitude of the slider align with the gripping mechanism side. By making the ABS contact the horizontal regulating surface after the slider is thus gripped by the pressing surfaces, the ABS does not slide along the horizontal regulating surface, whereby damage to the ABS can be prevented.

It should be noted that rotation about the center of mass of the slider becomes possible by setting a positional relationship such that the center of mass (centroid) of the slider substantially coincides with the rotation axis of the driving means when the slider is thus sandwiched by the gripping mechanism.

Further, the reflectivity of light in the periphery of the slider decreases with respect to a rear surface of the slider by beveling an edge portion of the pressing surface. The outline of the slider thus becomes clear, and the external shape of the slider can be accurately found by image recognition.

In addition, when an urging force of the pressing surface of one block, which is set in advance, is made larger than an urging force of the other block when gripping the slider with the pressing surfaces, the slider will be pressed by the block that applies the larger urging force when the slider is gripped, and will move within a sliding range of the block that applies the smaller urging force. It thus becomes easy to specify a gripping position for the slider when gripping the slider, and it becomes possible to easily perform slider position detection and the like thereafter.

The driving means is once again operated after the gripping mechanism grips the slider, thus inserting the gripping mechanism into the gap formed by the insertion member between the plurality of suspensions. It should be noted that, when distal end positions of the suspensions and the position of the slider that is to be attached are found in advance by image recognition or the like when inserting the gripping mechanism into the gap, the slider may be aligned with the position of the distal ends of the suspensions by using the driving means based on the position information.

The distal ends of the suspensions are managed in the height direction thereof by the insertion member so as to have an accurate dimension. Consequently, it becomes possible to attach the slider to the distal ends of the suspensions, without applying an excessive load to the slider or the suspensions, by using connecting means such as an adhesive applied to a rear surface of the slider in advance, tacking with solder, or a combination of these methods, by moving the gripping means in the height direction and bringing the slider into contact with the distal ends of the suspensions.

It should be noted that, although a procedure for attaching the slider to the suspension after attaching the suspension to the actuator block is explained above, other procedures may also be used. For example, the slider may also be post mounted to the slider alone, or the slider may also be post mounted after assembling the suspension and an arm.

The suspension is thus not positioned on the opposing side in such cases. Accordingly, the suspensions to which the slider is to be attached are pressed, moving the distal ends of the suspensions to a height set in advance. After the distal ends of the suspensions are thus moved to a prescribed height, the gripping mechanism grips the slider, similar to the suspensions that are attached to the actuator block. The slider may then be attached to the distal ends of the suspensions after being positioned with respect to the distal ends of the suspensions. Further, setting the distal ends of the suspensions to the prescribed height need not be performed by pressing on the suspensions. The height of the distal ends of the suspensions may also be set by mounting the suspensions onto a stage (not shown), for example. It should be noted that the gripping mechanism grips side walls of the slider, and then brings the ABS into intimate contact with the horizontal regulating surface, thus adjusting the horizontal attitude of the slider. Consequently, the ABS is not damaged. It thus becomes possible to obtain a stable flying attitude and a stable flying amount for the slider, and good electrical characteristics for the slider can be obtained.

As explained above, the present invention provides a method of manufacturing a magnetic head in which a slider is attached to suspensions attached to an actuator block, the method including: pushing open the plurality of opposing suspensions; forming the gap having a prescribed height between distal ends of the suspensions to which the slider is to be attached, gripping both the side surfaces of the slider by the pressing surfaces formed on the gripping mechanism; regulating the horizontal attitude of the slider by bringing the ABS of the slider into contact with the horizontal regulating surface formed on the gripping mechanism; inserting the slider, which is held by the gripping mechanism, into the gap; and attaching a rear surface of the slider to the distal ends of the suspensions by using the connecting means. Further, the present invention provides a magnetic head manufacturing apparatus in which a slider is attached to suspensions attached to an actuator block, the magnetic head manufacturing apparatus including at least: the insertion member that is inserted between the plurality of opposing suspensions, for holding distal ends of the suspensions to which the slider is to be attached at a prescribed height and forming the gap between the opposing suspensions; the gripping mechanism made from two block structure members that are capable of sliding with respect to each other, the gripping mechanism being adapted to grip the slider by pressing with the pressing surfaces formed on the block members, and to horizontally regulate the slider by the horizontal regulating surface that is formed on one of the block members and contacts the ABS of the slider; and driving means for operating the gripping mechanism to insert the slider into the gap between the suspensions, and to press the slider onto the distal ends of the suspensions, based on position information on the distal ends of the suspensions and position information on the slider that is held by the gripping mechanism. Therefore, it becomes possible to post mount the slider, even when the suspensions and the actuator block are previously assembled together, whereby breakage of the slider due to ESD and the like can be prevented.

### BRIEF DESCRIPTION OF THE DRAWINGS

FIGS. 1A and 1B are apparatus explanatory diagrams that show the structure of a magnetic head manufacturing apparatus according to an embodiment of the present invention;

FIG. 2 is a side view of the gripping mechanism according to the embodiment;

FIG. 3 is an explanatory diagram that shows an opening and closing structure of the gripping mechanism;

FIG. 4 is an enlarged diagram of main portions of FIG. 3;

FIGS. 5A and 5B are explanatory diagrams that show differences in image recognition due to the presence/absence of beveled portions, of which FIG. 5A shows an image for a case where the beveled portions do not exist, and FIG. 5B shows an image for a case where the beveled portions exist; and

FIGS. 6A and 6B are explanatory diagrams that show how a slider is held by a first pressing surface and a second pressing surface.

### DESCRIPTION OF THE PREFERRED EMBODIMENTS

Preferred embodiments of a method of manufacturing a magnetic head and a magnetic head manufacturing apparatus according to the present invention are explained in detail below.

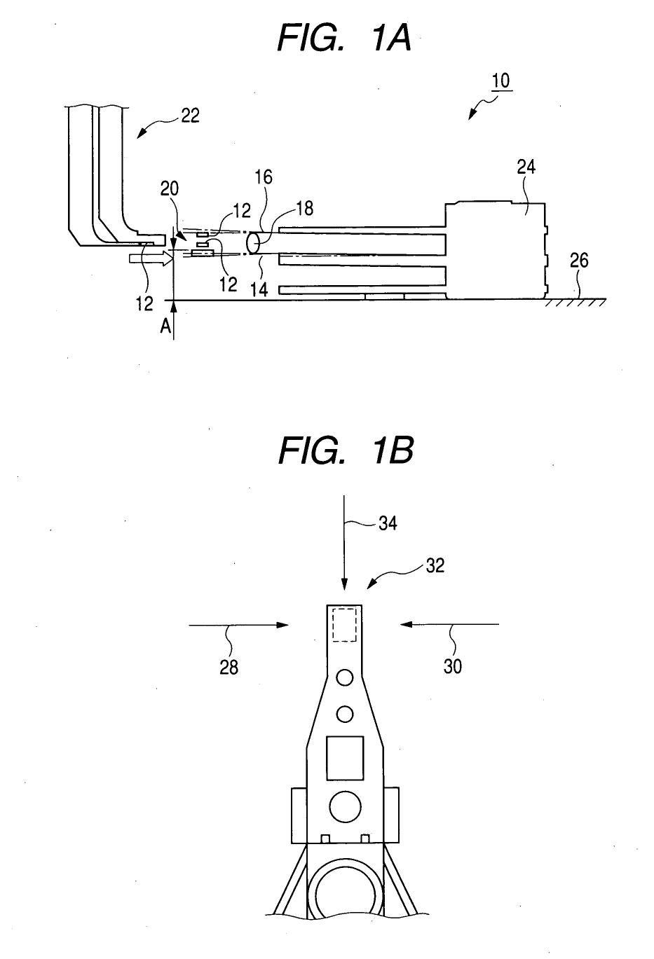

FIGS. 1A and 1B are apparatus explanatory diagrams that show the structure of a magnetic head manufacturing apparatus according to an embodiment of the present invention. As shown in FIG. 1A, a magnetic head manufacturing apparatus 10 according to this embodiment includes an insertion member 18 that is inserted in between a suspension 14, to which a slider 12 is to be attached, and a suspension 16 that opposes the suspension 14, and a gripping mechanism 22 that inserts the slider 12 into a gap 20 formed by inserting the insertion member 18 in between the suspensions 14 and 16, and attaches the slider 12 to a distal end of the suspension 14.

The insertion member 18, which pushes open the suspension 14 and the suspension 16, is positioned with good precision with respect to an HDD attachment reference surface 26 in an actuator block 24, and a distal end portion of the suspension 14, to which the slider 12 is to be attached, is maintained with good precision at a preset dimensional position by making the insertion member 18 contact an intermediate portion of the suspension 14 and the suspension 16.

On the other hand, the gripping mechanism 22 that attaches the slider 12 to the distal end portion of the suspension 14 is configured by a structural member made from two blocks (structural details are described hereinafter). It should be noted that the gripping mechanism 22 is shown in FIG. 1A on the distal end side of the suspension 14 and the suspension 16. This shows that the gripping mechanism 22 is inserted in the gap 20, and does not indicate that the gripping mechanism 22 is inserted from the distal end side of the suspensions (in other words, the side on which a terminal electrode of the slider 12 is formed.).

FIG. 1B shows a direction along which the gripping mechanism 22 is inserted in the gap 20. Namely, the gripping mechanism 22 is inserted from a direction denoted by an arrow 28 or an arrow 30 (longitudinal sides of the suspension), or from a direction denoted by an arrow 34, as shown in FIG. 1B. The gripping mechanism 22 grips a portion other than the terminal electrode surface of the slider 12 at this point. Accordingly, even if a mechanism that electrically connects a terminal electrode (not shown) formed on a distal end side 32 of the slider 12 approaches from the direction of the arrow 34 after the slider is attached to the distal end of the suspension 14, the mechanism that electrically connects the slider 12 and the gripping mechanism 22 do not interfere with each other.

The gripping mechanism 22 that grips the slider 12 and attaches the slider 12 to the suspension 14 is explained below.

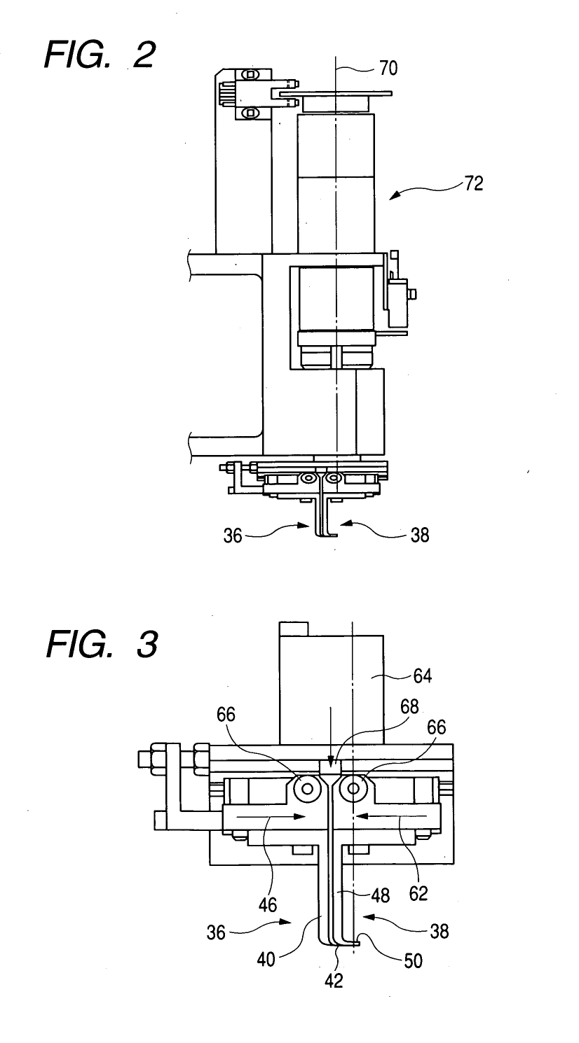

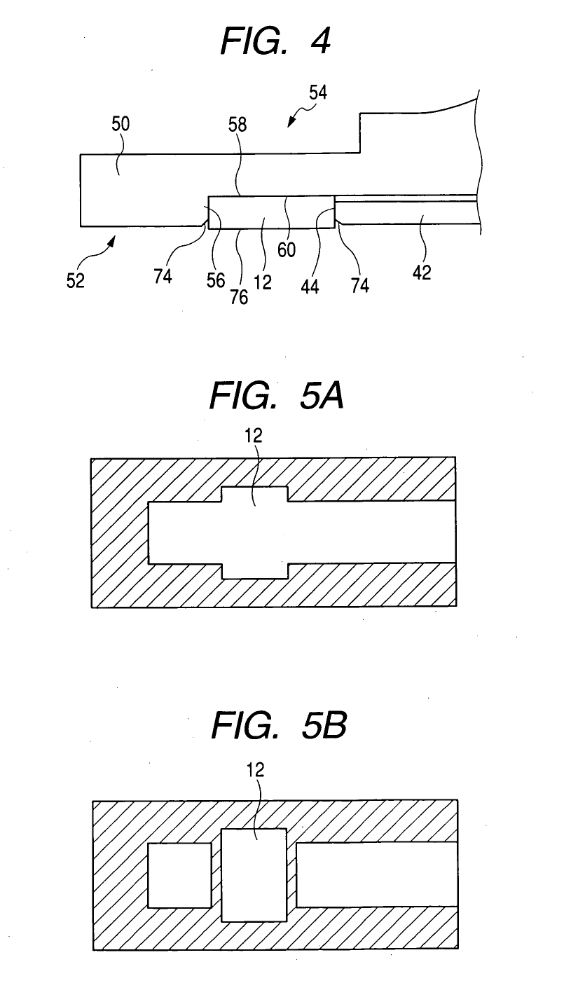

FIG. 2 is a side view of the gripping mechanism according to this embodiment, FIG. 3 is an explanatory diagram that shows an opening and closing structure of the gripping mechanism, and FIG. 4 is an enlarged diagram of main portions of FIG. 3.

As shown in those figures, the gripping mechanism 22 according to this embodiment is composed of two block members, a first block 36 and a second block 38, so that the slider 12 can be sandwiched therebetween.

In the first block 36 that configures the gripping mechanism 22, a first plate portion 40 that extends in a vertical direction is provided in a center portion thereof. A first projecting piece 42 that projects out from a side of the first plate portion 40 in an L-shape is provided in a lower edge portion thereof. It should be noted that the first projecting piece 42 is formed thinner than at least the slider 12 that is to be gripped. The first projecting piece 42 thus does not interfere with the suspension 14 when the side surface of the slider 12 is gripped by a first pressing surface 44 formed on a distal end of the first projecting piece 42 and the slider 12 is inserted into the gap 20.

Furthermore, a guiding mechanism (not shown) is provided on an upper end portion side of the first block 36. The first block 36 can move reciprocally within a range set in advance in a direction that is orthogonal with respect to the first pressing surface 44. Further, a spring (hereinafter called a first spring) is latched to the first block 36 so as to urge the first block 36 in a direction shown by an arrow 46 of FIG. 3.

On the other hand, a second plate portion 48 that extends in a vertical direction is provided in a center portion of the second block 38 that configures the gripping mechanism 22, similar to the first block 36. A second projecting piece 50 that projects out from a side of the second plate portion 48 in an L-shape is provided on a lower end portion side of the second plate portion 48. It should be noted that a distal end portion 52 of the second projection piece 50 is formed thicker than an intermediate portion 54, making it possible to grip the slider 12 by a second pressing surface 56 formed along the raised portion extending from the intermediate portion 54 to the distal end portion 52, and the first pressing surface 44 that is formed in the distal end of the first block 36. Further, a horizontal regulating surface 60 is formed on a side that opposes an ABS 58 of the slider 12 in the intermediate portion 54. By bringing the ABS 58 of the slider 12 into intimate contact with the horizontal regulating surface 60, the attitude of the slider 12 can be made in conformity with the second plate portion 48 (the slider 12 can be gripped horizontally).

Furthermore, a guiding mechanism (not shown) is provided on an upper end portion side of the second plate portion 48, similar to the first block 36. The second block 38 can move reciprocally within a range set in advance in a direction that is orthogonal with respect to the second pressing surface 56. Further, a spring (hereinafter called a second spring) is latched to the second block 38 so as to urge the second block 38 in a direction shown by an arrow 62 of FIG. 3. It should be noted that a force of the first spring is set to be stronger than that of the second spring in this embodiment, so that an urging force on the first block 36 becomes large compared to an urging force on the second block 38 (a relationship between the magnitudes of the urging forces is shown by the sizes of the arrow 46 and the arrow 62 in FIG. 3).

By positively setting a difference between the urging force of the first block 36 and the urging force of the second block 38 in this way, one surface of the slider 12 is positioned by the urging force of the first block 36 while taking as a reference the first pressing surface 44 moved to a movable end surface by the urging force of the first block 36, and the position of the second pressing surface 56 of the second block 38 is determined by the position of the other surface of the slider 12. It thus becomes possible to maintain a constant relative position between the slider 12 and the gripping mechanism 22 when the slider is gripped.

The first block 36 and the second block 38, which are held in intimate contact with each other due to spring urging, are spread open by an air cylinder 64 that is disposed above the first block 36 and the second block 38. In other words, a pair of rollers 66 are disposed on the first block 36 and the second block 38, and the urging forces of the first block 36 and the second block 38 can be overcome by making a rod 68 of the air cylinder 64 contact the pair of rollers 66. It thus becomes possible to open and close a space between the blocks. Therefore, by moving the rod 68 of the air cylinder 64 reciprocally, the space between the blocks can be opened and closed.

Further, a servo motor 72 that serves as a rotation driving means for causing the first block 36 and the second block 38 to rotate about a Z-axis 70 is also provided above the first block 36 and the second block 38. It should be noted that the Z-axis 70, which is the axial center of the servo motor 72, is set to pass through the center of mass (centroid) of the slider 12 that is held by the gripping mechanism 22. The slider 12 does not deviate from the Z-axis 70 when correcting tilt of the slider 12, and consequently, miniaturization of the apparatus itself can be achieved. Although the Z-axis 70 is set to pass through the center of mass (centroid) of the slider 12 being held by the gripping mechanism 22 in this embodiment, there are no limitations placed on this arrangement. For example, when the Z-axis cannot pass through the center of mass (centroid) of the slider 12 due to design restrictions (such as space restrictions), the Z-axis may be placed as near as possible to the center of mass (centroid) of the slider 12. It thus becomes possible to perform corrections to slider tilt within a minimum range provided that the Z-axis 70 is placed as near as possible to the center of mass (centroid) of the slider 12.

Beveled portions 74 are formed in edge portions of the first pressing surface 44 and the second pressing surface 56, thus reducing the reflectivity of light in a vertical direction as compared to that of a rear surface 76 of the slider 12.

FIGS. 5A and 5B are explanatory diagrams that show differences in image recognition due to the presence/absence of the beveled portions 74. FIG. 5A is an image for a case where the beveled portions 74 do not exist, while FIG. 5B is an image for a case where the beveled portions 74 exist. As shown in FIGS. 5A and 5B, the edge boundary line of the slider 12 is unclear when the bevel portions 74 do not exist in the edge portions of the first pressing surface 44 and the second pressing surface 56, and there is a fear that the position detecting accuracy for the slider 12 will decrease. However, the edge boundary line of the slider 12 becomes clear when the bevel portions 74 are formed in the edge portions of the first pressing surface 44 and the second pressing surface 56. The position detecting accuracy for the slider 12 can thus be increased.

It should be noted that the gripping mechanism 22 described above is connected to driving means such as a servo motor (not shown). The driving means performs gripping of the slider 12 by the gripping mechanism 22, and inserts the gripped slider 12 into the gap 20 between the suspensions 14 and 16, thus making it possible to press the slider 12 onto the distal end of the suspension 14 to which the slider 12 is to be attached. The driving means performs these actions based on position information regarding the external shape and the center of mass (centroid) of the slider 12, and the distal ends of the suspension 14 to which the slider 12 is to be attached. The position information is detected by a camera (not shown).

When using the magnetic head manufacturing apparatus 10 configured as described above, first an image recognition camera photographs a tray in which a plurality of the sliders 12 are received, or the slider 12 that has been moved from the tray onto a temporary holding stand or the like, thus obtaining the position information thereof. The driving means then moves the gripping mechanism 22 to a position above the slider 12 based on the position information for the slider 12, and extends the rod 68 of the air cylinder 64 to separate the first block 36 and the second block 38 apart from each other. The first block 36 and the second block 38, thus separated from each other, cause the distance between the first pressing surface 44 and the second pressing surface 56 to become wider than the width of the slider 12. The rod 68 of the air cylinder 64 is then pulled back, causing the first block 36 and the second block 38 to move. The slider 12 is thus gripped by the first pressing surface 44 and the second pressing surface 56.

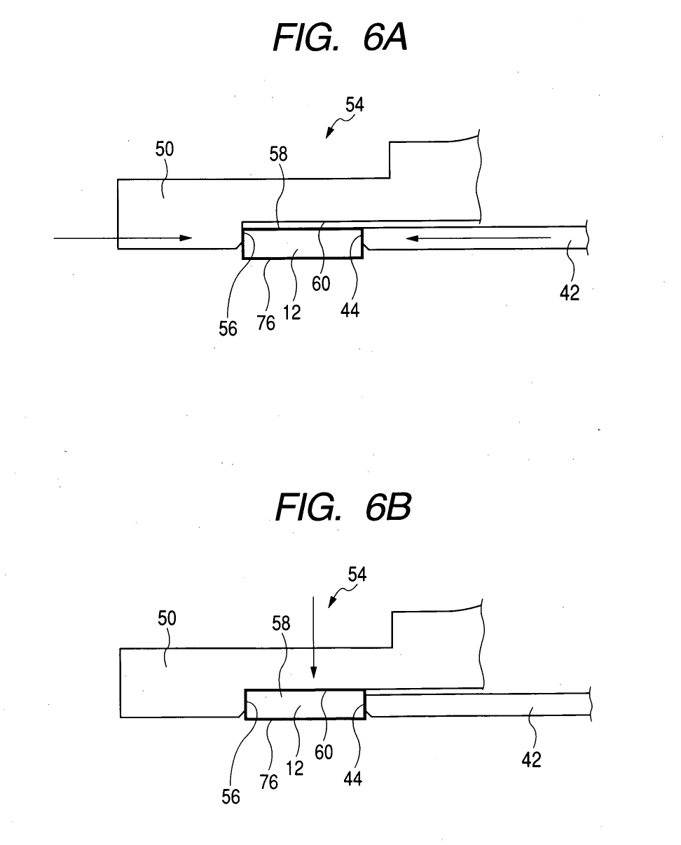

FIGS. 6A and 6B are explanatory diagrams that show how the slider is held by the first pressing surface 44 and the second pressing surface 56. That is, when the slider 12 is inserted as shown in FIG. 6A, first the slider 12 is sandwiched by the first gripping surface 44 and the second gripping surface 56 in a state where the ABS of the slider 12 is separated from the horizontal regulating surface 60. After the slider 12 is sandwiched by the first pressing surface 44 and the second pressing surface 56, the gripping mechanism 22 is lowered as shown in FIG. 6B, and the horizontal regulating surface 60 is made to contact the ABS 58. Sliding (side slipping) of the ABS 58 with respect to the horizontal regulating surface 60 thus does not occur provided that the slider 12 is held in position through the procedure from FIG. 6A to FIG. 6B. Abrasions and the like to the ABS 58 can thus be prevented.

After the slider 12 is held by the gripping mechanism 22, an adhesive serving as a connecting means for bonding the slider 12 to the suspension 14 is applied to the rear surface 76 of the slider 12, and the slider 12 is moved to the distal end of the suspension 14, which has been detected in advance by image processing. It should be noted that tilt of the slider 12 may be corrected by the time when the slider 12 is inserted into the gap 20. After completing positioning of the slider 12 in X and Y directions with respect to the distal end of the suspension 14, and correcting rotation about the Z-axis 70, the gripping mechanism 22 may be moved down, and the slider 12 may be attached to the suspension 14 by the adhesive.

It should be noted that the distal end of the suspension 14 is held in position with good precision by the insertion member 18 in this embodiment (position “A” of FIG. 1). Accordingly, a load that deviates from a set value, such as an excessive load (or a deficient load), is not applied to the slider 12. Consequently, attachment of the slider 12 to the suspension 14 can be performed with good precision. The slider 12 is post mounted, and it thus becomes possible to prevent damage to the slider 12 due to ESD or the like.

It should be noted that, although a two piece structure is used for the gripping mechanism 22 in this embodiment, other structures may also be employed. For example, the gripping mechanism 22 may have a three piece structure. A first pressing surface, a second pressing surface, and a horizontal regulating surface may each be formed independently on respective blocks constituting the three piece structure. It thus becomes possible to perform very fine control when holding the slider 12 provided that the three piece structure is used.

In addition, although a procedure for attaching the slider after attaching the suspensions to the actuator block is explained in this embodiment, other procedures may also be employed. For example, the slider may also be post mounted to the suspensions alone, or the slider may also be post mounted after the suspensions and an arm are assembled.

In the above case, the suspensions are not positioned on opposite sides. Consequently, a positioning member may be provided as a substitute for the insertion member 18 described above. When the positioning member is formed as a pressing member that presses an intermediate portion of the suspensions, distal ends of the suspensions are moved by the pressing member to height values set in advance. After thus setting the heights of the distal ends, attachment of the slider 12 may be performed by using the gripping mechanism 22 described above. It should be noted that the positioning member is not limited to the pressing member. For example, a stage may also be used as the positioning member instead of the pressing member. The suspensions may be mounted onto the stage (not shown), and the heights of the distal ends of the suspensions may be set in this state.

After side walls of the slider 12 are gripped by the gripping mechanism 22, the ABS is brought into intimate contact with the horizontal regulating surface 60, adjusting the horizontal attitude of the slider. Accordingly, damage is not caused to the ABS. A head gimble assembly (HGA) having a stable flying attitude and a stable flying amount can thus be obtained, and a head arm assembly (HAA) in which an arm is attached to the HGA can be obtained. Good electrical characteristics can be obtained when incorporating the HGA or the HAA into an HDD.

1. A method of manufacturing a magnetic head in which sliders are respectively attached to suspensions, comprising:
setting distal ends of the suspensions, to which the sliders are respectively to be attached, at prescribed heights;
gripping both side surfaces of each of the slider by pressing surfaces formed on a gripping mechanism;
regulating a horizontal attitude of each of the sliders by bringing an ABS of each of the sliders into contact with a horizontal regulating surface formed on the gripping mechanism;
moving each of the sliders, which is held by the gripping mechanism, to the distal ends of each of the suspensions; and
attaching a rear surface of each of the sliders to the distal ends of corresponding the suspensions through connecting means.

2. A method of manufacturing a magnetic head according to claim 1, wherein insertion of the gripping mechanism between the suspensions is performed from a longitudinal direction of the suspensions, preventing interference with a surface of the sliders each on which a terminal electrode is formed.

3. A method of manufacturing a magnetic head according to claim 1, wherein the holding of each of the sliders by the gripping mechanism comprises gripping both the side surfaces of each of the sliders by the pressing surfaces, making the gripping mechanism approach the slider, and bringing the horizontal regulating surface into contact with the ABS of each of the sliders.

4. A method of manufacturing a magnetic head in which a slider is attached to suspensions attached to an actuator block, the method comprising:
pushing open a plurality of the suspensions that face each other, forming a gap having a prescribed height between distal ends of the suspensions to which the sliders are respectively to be attached;
gripping both side surfaces of each of the sliders by pressing surfaces formed on a gripping mechanism;
regulating a horizontal attitude of each of the sliders by bringing an ABS of each of the sliders into contact with a horizontal regulating surface formed on the gripping mechanism;
inserting the sliders, each of which is held by the gripping mechanism, into the gap; and
attaching a rear surface of each of the sliders to the distal ends of corresponding the suspensions respectively by using connecting means.

5. A method of manufacturing a magnetic head according to claim 4, wherein insertion of the gripping mechanism between the suspensions is performed from a longitudinal direction of the suspensions, preventing interference with a surface of the sliders each on which a terminal electrode is formed.

6. A method of manufacturing a magnetic head according to claim 1, wherein the holding of the slider by the gripping mechanism comprises gripping both the side surfaces of each of the sliders by the pressing surfaces, making the gripping mechanism approach each of the sliders, and bringing the horizontal regulating surface into contact with the ABS of each of the sliders.

7. A magnetic head manufacturing apparatus in which sliders are respectively attached to suspensions, comprising at least:
a positioning member for retaining distal ends of the suspensions at prescribed heights;
a gripping mechanism made from two block structure members that are capable of sliding with respect to each other, the gripping mechanism being adapted to grip each of the sliders by pressing with pressing surfaces formed on the block members and to horizontally regulate each of the sliders by a horizontal regulating surface that is formed on one of the block members and contacts an ABS of each of the sliders; and
driving means for operating the gripping mechanism to move each of the sliders toward distal ends of the corresponding suspensions respective and to press the slider onto the distal ends of the suspensions, based on position information on the distal ends of the suspensions and position information on the sliders each of which is held by the gripping mechanism.

8. A magnetic head manufacturing apparatus according to claim 7, wherein the gripping mechanism is disposed by a side in a longitudinal direction of the suspensions, preventing interference with a surface of the sliders each on which a terminal electrode is formed.

9. A magnetic head manufacturing apparatus according to claim 7, wherein urging forces applied by the pressing surfaces to each of the sliders are made uneven between the block members, and a position of each of the sliders with respect to the gripping mechanism is set by pressing with the block member for which a larger urging force is set.

10. A magnetic head manufacturing apparatus according to claim 9, further comprising rotation driving means attached to the gripping mechanism, for making a rotation axis of the gripping mechanism pass through a vicinity of a center of mass of each of the sliders set by pressing of the block members, wherein operation of the rotation driving means enables rotation of the slider together with rotation of the gripping mechanism.

11. A magnetic head manufacturing apparatus according to claim 7, wherein the pressing surfaces each have a beveled portion formed at their edge portions, reducing reflectivity relative to the block member and the slider each of which is arranged on both sides of the beveled portion.

12. A magnetic head manufacturing apparatus in which a sliders are respectively attached to suspensions attached to an actuator block, the magnetic head manufacturing apparatus comprising at least:
an insertion member that is inserted between a plurality of the suspensions that face each other, for holding distal ends of the suspensions, to which each of the sliders is to be attached, at a prescribed height and for forming a gap between the suspensions that face each other;
a gripping mechanism made from two block structure members that are capable of sliding with respect to each other, the gripping mechanism being adapted to grip each of the sliders by pressing with pressing surfaces formed on the block members and to horizontally regulate each of the sliders by a horizontal regulating surface that is formed on one of the block members and contacts an ABS of each of the sliders; and
driving means for operating the gripping mechanism to insert each of the sliders into the gap between the suspensions, and to press the slider onto the distal ends of the suspensions, based on position information on the distal ends of the suspensions and position information on the slider each of which are held by the gripping mechanism.

13. A magnetic head manufacturing apparatus according to claim 12, wherein the gripping mechanism is disposed by a side in a longitudinal direction of the suspensions, preventing interference with a surface of each of the sliders on which a terminal electrode is formed.

14. A magnetic head manufacturing apparatus according to claim 12, wherein urging forces applied by the pressing surfaces to each of the sliders are made uneven between the block members, and a position of each of the sliders with respect to the gripping mechanism is set by pressing with the block member for which a larger urging force is set.

15. A magnetic head manufacturing apparatus according to claim 14, further comprising rotation driving means attached to the gripping mechanism, for making a rotation axis of the gripping mechanism pass through a vicinity of a center of mass of each of the sliders set by pressing of the block members, wherein operation of the rotation driving means enables rotation of the slider together with rotation of the gripping mechanism.

16. A magnetic head manufacturing apparatus according to claim 12, wherein the pressing surfaces each have a beveled portion formed at their edge portions, reducing reflectivity relative to the block member and the slider each of which is arranged on both sides of the beveled portion.
